(19) United States
(12) Patent Application Publication
(10) Pub. No.: US 2025/0143236 A1
(43) Pub. Date: May 8, 2025

(54) A METHOD FOR REMOTELY AND/OR AUTONOMOUSLY HARVESTING A TREE FROM AIR

(71) Applicant: AIRFORESTRY AB, Uppsala (SE)

(72) Inventors: Mauritz ANDERSSON, Uppsala (SE); Olle GELIN, Alunda (SE)

(21) Appl. No.: 18/834,148

(22) PCT Filed: Jan. 31, 2023
(86) PCT No.: PCT/SE2023/050080

§ 371 Date: Jul. 29, 2024

(30) Foreign Application Priority Data
Feb. 1, 2022 (SE) 2250095-3

(51) Int. Cl. A01G 23/083; B64D 1/22; B64U 10/16; B64U 20/80; B64U 101/40; B64U 101/67

(52) U.S. Cl. CPC A01G 23/083; B64D 1/22; B64U 10/16; B64U 20/80; B64U 2101/40; B64U 2101/67

(57) ABSTRACT

The present invention relates to a method for remotely and/or autonomously harvesting a tree from air. The method comprises detecting by at least one sensor on a UAV (100) a tree to be harvested, positioning a harvesting tool (105) comprising delimbing means (114) carried by the UAV (100), by using information from the at least one sensor, at a predetermined distance above a canopy of the tree to be harvested, releasing the harvesting tool (105) in a first mode from the UAV (100) from the predetermined distance above the canopy of the tree to be harvested, setting the harvesting tool (105) in a second mode when the harvesting tool (105) has the tree top (131) within its tree receiving area (177). At least a portion of the harvesting tool (105) is below the tree top (131) of the tree to be harvested while the harvesting tool (105) has a certain speed >0 in a downward direction. The first and second mode differ with respect to the tree receiving area (177) of the delimbing means (114) in the harvesting tool (105). The tree receiving area (177) refers to the area in between open and closed delimbing means (114).

### TECHNICAL FIELD OF THE INVENTION

The present invention relates in general to a method for tree harvesting, in particular it relates to a method for tree harvesting by using an Unmanned Aerial Vehicle, UAV and a harvesting tool attached to said UAV.

### BACKGROUND OF THE INVENTION

Traditional tree harvesting or tree falling has long been conducted by persons and equipment based on the ground. In earlier times, from the early twentieth century and going back to the early nineteenth century, little consideration was given to the state of the forest or to the eco-system within the forest. Logging was done on a massive scale to keep up with the demand caused by the industrial revolution and the subsequent expansion of human life at the time. Depending on the terrain, tree harvesting process usually begins with experienced tree fellers cutting down a stand of trees or by using heavy ground based manned harvesting machines.

The above-described methods represent a high level of risk, either to the environment or the people performing the work. Damage can also be done to the delicate ecology of the forest, known as the understory or underbrush, where smaller plants bind the soil together and provide a habitat to insects, birds, lichens, and fungus among other things.

Most importantly, many locations are extremely difficult to reach by land, even with the use of heavy equipment such as bulldozers, and removal of trees from such locations is expensive. Sometimes it may be desirable to harvest a single tree amongst a stand of trees, so called tree thinning, without disturbing the surrounding trees.

In U.S. Pat. No. 6,263,932 it is disclosed an aerial tree harvesting apparatus. A first body of said apparatus is suspended from an ordinary helicopter and a second body is suspended by cables from the first body. The apparatus is capable of delimbing and cutting the tree and thereafter transporting the harvested tree to another location.

The problem with U.S. Pat. No. 6,263,932 is that delimbing may require unnecessary amount of time, man hours and/or unnecessary amount of power due to inefficient delimbing technique.

### SUMMARY OF THE INVENTION

The present invention aims at obviating the aforementioned problem. A primary object of the present invention is to provide an improved remotely and/or autonomously harvesting method enabling an efficient delimbing step.

According to the invention at least the primary object is attained by means of the payload having the features defined in the independent claims. Preferred embodiments of the present invention are further defined in the dependent claims.

According to a first aspect of the present invention it is provided a method for remotely and/or autonomously harvesting a tree from air, the method comprising the steps of:
a. detecting by at least one sensor on a UAV a tree to be harvested,
b. positioning a harvesting tool comprising delimbing means carried by the UAV, by using information from the at least one sensor, at a predetermined distance H above a canopy of the tree to be harvested,
c. releasing the harvesting tool in a first mode from the UAV from the predetermined distance H above the canopy of the tree to be harvested, and
d. setting the harvesting tool in a second mode when the harvesting tool has the tree top of the tree to be harvested within its tree receiving area, wherein
at least a portion of the harvesting tool is below the tree top of the tree to be harvested while the harvesting tool has a certain speed >0 in a downward direction,
the first and second mode differ with respect to the tree receiving area of the delimbing means in the harvesting tool, and
the tree receiving area refers the area in between open and closed delimbing means.

The advantage of this embodiment is that it provides for a method with reduced risk of missing a tree top with a tree receiving area of the harvesting tool. Another advantage is that the harvesting tool with its speed and weight when arriving at the tree top will increase the speed of gravity delimbing and increase the likelihood of a successful complete deliming of a tree.

In various example embodiments of the present invention, the method further comprising the step of detecting a relative position of the tree top of the tree to be harvested and the UAV and/or the harvesting tool.

The advantage of these embodiments is that a predetermined releasing height of the harvesting tool may be set once the UAV with the tool has arrived at the tree to be harvested.

In various example embodiments of the present invention, the tree top of the tree to be harvested is detected by means of at least one out of at least three different stereo images.

The advantage of these embodiments is that tree tops may be detected despite larger trees nearby, which may be an obstacle when trying to detect tree tops from certain directions.

In various example embodiments of the present invention, the method further comprising the step of delimbing the tree to be harvested by the gravity force induced by the harvesting tool when released from the UAV.

The advantage of these embodiments is that different releasing height and/or different weight of the harvesting tool may be chosen for different types of trees.

In various example embodiments of the present invention, the method further comprising the step of detecting with at least one detector a portion of a tree within the tree receiving area of the harvesting tool.

The advantage of these embodiments is that switching from the first to second mode may be triggered by the detection of a tree top within the tree receiving area of the harvesting tool.

In various example embodiments of the present invention, the method further comprising the step of stopping the release of the harvesting tool in case of failure to detect any portion of a tree within the tree receiving area.

The advantage of these embodiments of the present invention is that the release of the harvesting tool may be stopped to prohibit damage of the harvesting tool in case of missing the tree.

In various example embodiments of the present invention, the stopping is occurring within a predetermined time interval after the start of releasing the harvesting tool from the UAV and/or within a predetermined speed interval of the harvesting tool without detection of any tree top within the receiving area of the harvesting tool.

The advantage of these embodiments is that the harvesting tool may be stopped well in advance before hitting ground. Another advantage is that the harvesting tool may be stopped before reaching a too high speed which may limit the applied braking force.

In various example embodiments of the present invention, the harvesting tool is released at a height H of 0.1-5 meter above the canopy of the tree to be harvested.

The advantage of these embodiments is that the starting speed of the harvesting tool when reaching the tree top may be varied.

In various example embodiments of the present invention, the harvesting tool is triggered to be set into the second mode by at least one of the group of following triggers: at a predetermined distance between the UAV and the harvesting tool, when a tree is detected to be within the tree receiving area of the harvesting tool, a certain speed of the harvesting tool and/or within a predetermined time interval after the harvesting tool is released from the UAV.

The advantage of these embodiments is that one or a plurality of triggers may be used alone or in combination in order to determine when the harvesting tool should be switched from one mode to another.

In various example embodiments of the present invention, the detection of a tree within the tree receiving area of the harvesting tool is made by at least one optical device provided on the UAV and/or the harvesting tool.

The advantage of these embodiments is a redundancy of detection arrangements. Another advantage is that one or a plurality of tree parameters may require a combination of sensors on the UAV and the harvesting tool to safely detect a tree within the tree receiving area.

In various example embodiments of the present invention, a switching from the first mode to the second mode is performed autonomously.

The advantage of these embodiments is that the switching mechanism may be performed without any human assistance.

In various example embodiments of the present invention, the tree receiving area in the first mode is at least twice as big as the tree receiving area in the second mode.

The advantage of this embodiment is that the likelihood of receiving the tree within the tree receiving area is increased by increasing the tree receiving area.

In various example embodiments of the present invention, the tree receiving area in the second mode is adapted to the diameter of the tree trunk of the tree to be harvested.

The advantage of these embodiments is that the delimbing may be performed as close to the tree trunk as possible. In various example embodiments delimbing means which may represent a boundary of the varying tree receiving area may be resilient meaning that the delimbing means may be self-adapted to the diameter of the tree trunk in the second mode.

In various example embodiments of the present invention, the harvesting tool is attached to the UAV with at least two cables each provided with a winch mechanism during the first and second mode.

The advantage of these embodiments is that the harvesting tool may be tilted to a desired position by adjusting the length of the cables in an appropriate manner.

In various example embodiments of the present invention, the harvesting tool is moving in a direction essentially in parallel with the tree trunk of the tree to be harvested with a speed greater than 1 m/s when the switching from the first mode to the second mode is performed.

The advantage of these embodiments is that the harvesting tool has a sufficient speed in combination with its weight in order to successfully delimb a tree by the own weight of the harvesting tool.

In various example embodiments of the present invention, further comprising the steps of detecting at least one tree parameter, adjusting the releasing height above the tree canopy depending on the at least one tree parameter.

The advantage of these embodiments is that different trees species and/or age of trees may require different speed of a predetermined harvesting tool in order to successfully delimb the tree. In various example embodiments specific tree parameters which may be known beforehand may trigger to choose a certain harvesting tool, i.e., older trees may require a heavier tool than a younger tree of the same species.

In another aspect of the present invention, it is provided a computer-implemented method for harvesting a tree from air, the method comprising the steps of:
detecting with at least one sensor a tree to be harvested,
positioning, via execution of at least one control unit, a harvesting tool comprising delimbing means carried by a UAV, by using information from the at least one sensor, at a predetermined distance above a canopy of the tree to be harvested,
releasing, via execution of at least one control unit, the harvesting tool in a first mode from the UAV from the predetermined distance above the canopy of the tree to be harvested, and
setting, via execution of at least one control unit, the harvesting tool in a second mode when the harvesting tool has the tree top of the tree to be harvested within its tree receiving area, wherein
at least a portion of the harvesting tool is below the tree top of the tree to be harvested while the harvesting tool has a certain speed >0 in a downward direction,
the first and second mode differ with respect to the tree receiving area of the delimbing means in the harvesting tool, and
the tree receiving area refers to the area in between open and closed delimbing means.

In various example embodiments of the present invention, the UAV and the harvesting tool are configured to communicate with each other via one or more of Wifi, Bluetooth, radio communication, optical fibre and/or electrical wire.

The advantage of these embodiments is that various means of remote communication between a UAV and ligno harvesting tool may be used.

Further advantages with and features of the invention will be apparent from the following detailed description of preferred embodiments.

### BRIEF DESCRIPTION OF THE DRAWINGS

A more complete understanding of the abovementioned and other features and advantages of the present invention will be apparent from the following detailed description of preferred embodiments in conjunction with the appended drawings, wherein:

FIG. 1a-c depict various schematic side perspective views of example embodiments of an autonomous harvesting apparatus capable of performing the inventive method according to the present invention,

FIG. 2-4 depict various steps of the inventive harvesting method according to the present invention,

FIG. 5 depicts an example embodiment of a harvesting tool, and

FIG. 6 depicts a block diagram illustrating an example of a machine upon which one or more embodiments may be implemented.

### DETAILED DESCRIPTION OF PREFERRED EMBODIMENTS OF THE INVENTION

The word ligno used hereinabove and hereinbelow is a generic term for any tree(s) and/or any bush(es), in particular tree(s).

The word harvesting used hereinabove and hereinbelow is a generic term for removing at least a portion from a ligno, i.e., delimbing a ligno, cutting a portion of the ligno, cutting the full ligno and/or removing the ligno with at least a portion of its roots from the ground.

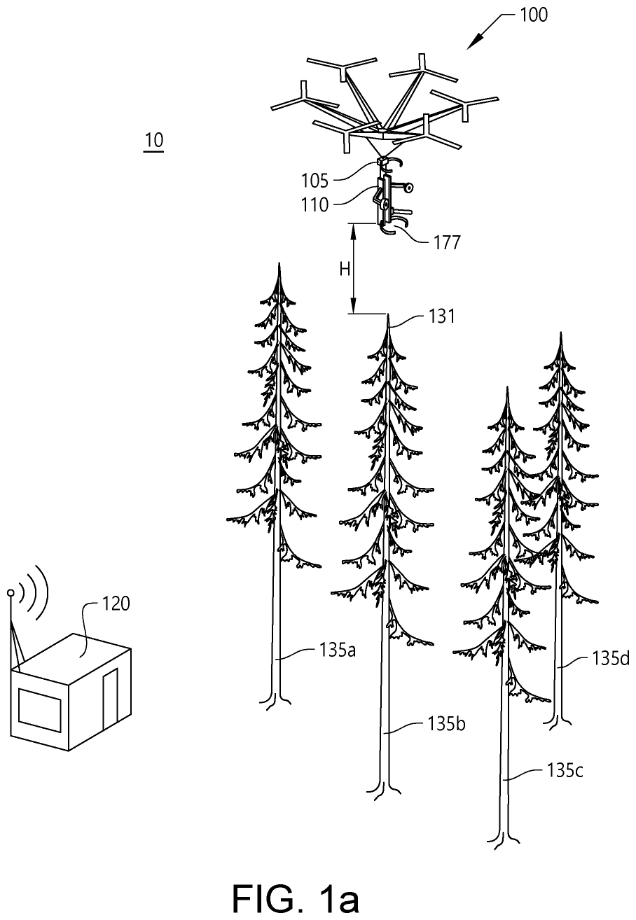

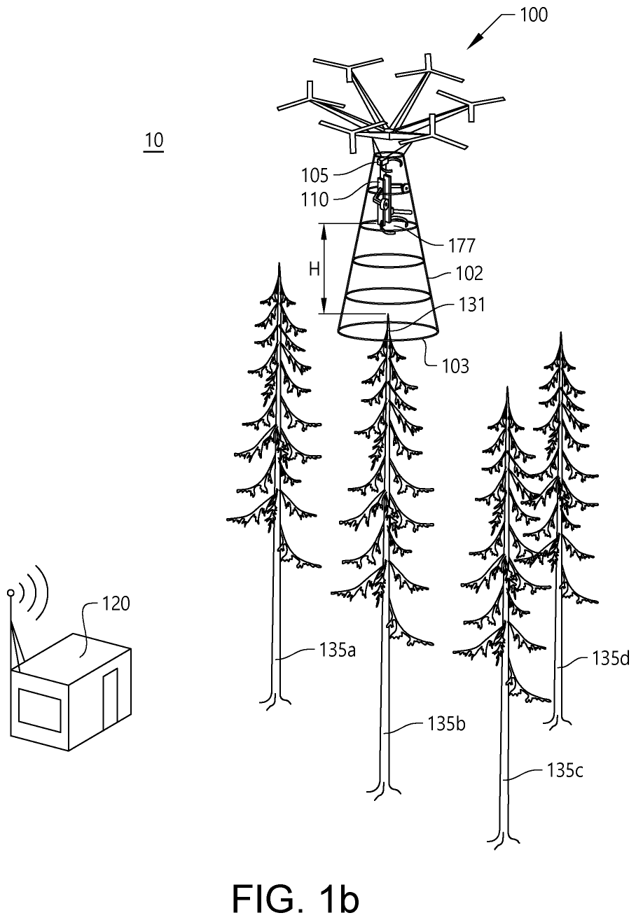

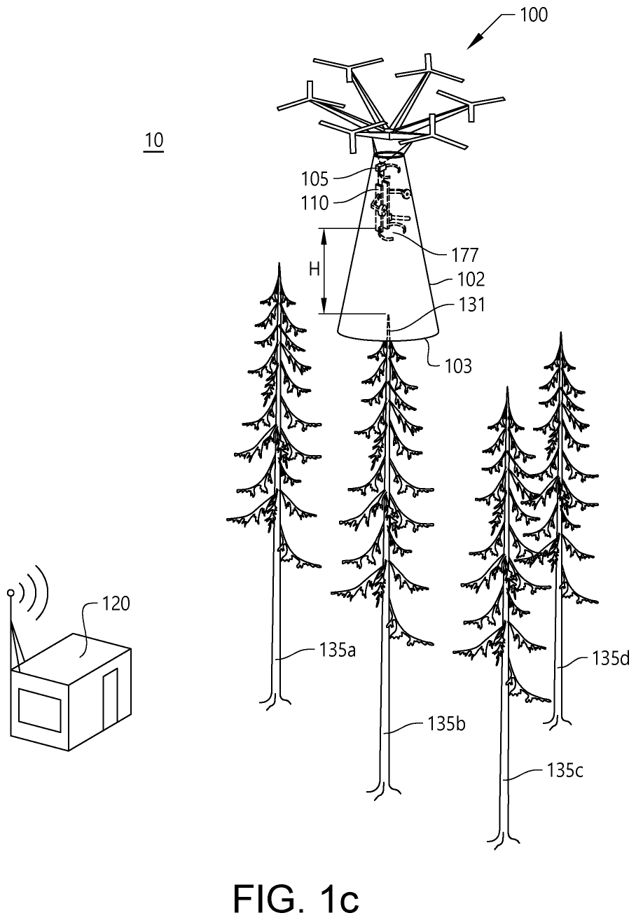

FIGS. 1-4, depict schematic pictures of different inventive remote and/or autonomous harvesting steps of at least a portion of a ligno by using an example embodiment of an autonomous harvesting system 10. The system 10 may comprise a remotely and/or autonomously controlled means configured for harvesting and/or transporting at least a portion of a ligno 105,110, a remotely and/or autonomously controlled Unmanned Aerial Vehicle 100, UAV, comprising, at least one means for holding 105 the ligno trunk and being configured for transporting the harvested portion of the ligno to another location, wherein the system comprising at least one means for detecting the ligno to be harvested and/or transported, and a base station 120 for controlling the means configured for harvesting and/or transporting at least a portion of a ligno and the UAV. The system 10 may further comprise means for detecting at least one ligno parameter of at least a portion of a ligno and/or at least one growing condition of at least a portion of a ligno. The system 10 may further comprise means configured for selecting at least a portion of a ligno to be harvested and/or transported depending on at least one detected ligno parameter and/or at least one detected growing condition of the transported/harvested portion of a ligno and/or a remaining portion of a ligno and/or of at least one ligno grown within a predetermined distance from the transported portion of a ligno.

In FIG. 1a the UAV 100 is carrying the remotely and/or autonomously controlled means configured for harvesting at least a portion of a ligno 105, 110. The UAV 100 is remotely controlled by the base station 120 and/or autonomously controlled and optionally communicating with base station 120. The base station 120 may be a stationary unit or a mobile unit.

In FIGS. 1-4 the UAV 100 can be considered as a forestry forwarder and the means configured for harvesting at least a portion of a ligno 105, 110 can be considered to be a forestry harvester. the means configured for harvesting at least a portion of a ligno 105, 110 may comprise a holding means 105 and a delimbing and cutting means 110.

In an autonomously controlled means configured for harvesting at least a portion of a ligno the means is able to operate without being controlled directly by humans whereas in a remotely controlled means configured for harvesting at least a portion of a ligno the means is able to be operated from a remote distance controlled directly by humans. In various example embodiment the means configured for harvesting at least a portion of a ligno and the UAV are remotely controlled. In various example embodiment the means configured for harvesting at least a portion of a ligno and the UAV are autonomously controlled. In various example embodiments the means configured for harvesting at least a portion of a ligno is remotely controlled and the UAV is autonomously controlled. In various example embodiments the means configured for harvesting at least a portion of a ligno is autonomously controlled and the UAV is remotely controlled.

The means for detecting a ligno may be at least one of a camera or an optical sensor. The camera may be at least one of for example an IR-camera (Infrared-camera), NIR-camera (Near Infrared-camera), a VISNIR-camera (Visual Near Infrared-camera), a CCD camera (Charged Coupled Device-camera), a CMOS-camera (Complementary Metal Oxide Semiconductor-camera), a digital camera, a 3D camera e.g., stereo camera, time-of-flight camera or LiDAR. The optical sensor may at least one of a photodetector, pyrometer, proximity detector and/or an infrared sensor.

The means for detecting a ligno may be arranged on the UAV and/or the means configured for harvesting at least a portion of a ligno.

The means for detecting at least one of the group of ligno parameters may be the same means as being used for detecting a ligno and/or an additional means. The additional means may be at least one of a camera or an optical sensor. The camera may be at least one of for example an IR-camera (Infrared-camera), NIR-camera (Near Infrared-camera), a VISNIR-camera (Visual Near Infrared-camera), a CCD camera (Charged Coupled Device-camera), a CMOS-camera (Complementary Metal Oxide Semiconductor-camera), a digital camera, a 3D camera e.g., stereo camera, time-of-flight camera or LiDAR, a spectral camera, a heat sensitive camera, an ultrasonic measurement device, a radar device, a vibration device. The optical sensor may be at least one of a photodetector, pyrometer, proximity detector and/or an infrared sensor. A 3D picture may see through foliage and/or branches. A mean value of multiple 3D images may result in mm precision images. 3D pictures may reveal lots of information about branches, ligno trunk and/or ligno species. 3D images may be taken from an airborne vehicle such as an UAV. The spectral camera may be used for measuring vegetation index (NDVI), i.e., a measure of the photosynthesis in a particular area. Heat sensitive cameras may be used for measuring the temperature of the surface of the ligno trunk which in turn may be a measure of the health of the ligno, an insect infestation ligno has a higher surface temperature than a non-infested ligno. Ultrasonic measurement and/or radar may be used for determining the inner form of the ligno, i.e., rotten or hollow inner structure and/or the inner moisture content of the ligno. Computer tomography and/or magnetic resonance imaging can give information about a portion of a ligno down to a ligno cell level.

The means for detecting at least one of the group of ligno parameters may be a camera or optical sensor in combination with Artificial Intelligence Al. Al may be used for training a model for recognizing one or a plurality of the ligno parameters. Ligno parameters may be recognized visually and/or by measurement and/or by at least one physical sample. Measurement may be made by optical inspection at a distance from the ligno and/or by physical measurement, for instance integrated in the means for gripping/holding 105 the ligno trunk. The means for detecting at least one ligno parameter may be a laser scanner attached to the UAV and/or the means for holding the ligno trunk and/or the means for harvesting the at least a portion of a ligno. By laser scanning the ligno trunk the ligno species may be determined and other surface conditions of the ligno trunk such as the presence of any moss and/or any damage. Detected ligno parameters may be compared with stored ligno parameters in a database for categorization and/or future choice and/or prioritization.

The final destination of the at least a portion of the ligno may be determined by at least one of the detected ligno parameters and/or at least one detected growing condition. Ligno parameters can be considered to be intrinsic features and growing conditions can be considered to be extrinsic features.

Ligno parameters may for instance be a diameter of the at least a portion of a ligno (top diameter, base diameter, mean diameter, median diameter), length of the at least a portion of a ligno, ligno species of the at least a portion of a ligno and/or the weight of the at least a portion of a ligno, dry content, age of ligno, number of annual rings, distance between annual rings, colour of annual rings, width of annual rings, amount of leaves, amount of fir needle, colour, chemical composition of the ligno, twig-free, deformation(s), cracks (dry cracks (partial or all trough), end crack, ring crack), rootstock, density, rot, discoloured, dead ligno, insect infested, microorganism infested, weather damage (storm, wind, fire, drought), machine damage (root, ligno trunk), amount of fruits, seeds, berries, nuts, cones, flowers on the ligno, form of root, root structure, root depth, root volume etc. The colour of the ligno may be an indicator of ligno species. The colour may be the colour of the outer surface of the ligno trunk or the colour of a cut area. The form of the ligno may be determined by a 3D camera. Form may comprise total volume of ligno, leaves or fir needles, deformations, shape deviations etc. Ligno parameters may also comprise material properties of the ligno such as moisture content (%), tensile strength (MPa), flexural strength (MPa), compressive strength (MPa), shear strength (MPa), impact strength (KJ/m2), hardness (Brinell, Vickers, Rockwell), elasticity module (MPa), thermal conductivity (W/m° C.), heat capacity (J/kg° C.), Calorific value (MJ/kg), etc.

In various example embodiments the ligno parameters may be detected manually by human or remote and/or autonomous by a separate unit prior to harvesting. Ligno parameters may be stored digitally together with GPS position. In various example embodiments a digital marker may be arranged physically on ligno prior to cutting the ligno or when the ligno is laying on ground. The digital marker may have stored information about at least one ligno parameter. The input of ligno parameters may be made manually prior to harvesting. The digital marker may be configured to communicate with the UAV. The communication may be performed by Bluetooth, WiFi, radio communication and/or telecommunication (3G, 4G, 5G). A physical sample for detecting ligno parameters such as density, rot and/or dry content may be made manually prior to harvesting and/or automatically by a sample detection means added to the means for holding the ligno trunk and/or the means configured for harvesting at least a portion of a ligno. Such sample detection means may be a suitable tool for removing a predetermined amount of the ligno to be analysed. The removal of the predetermined amount to be analysed may be made by drilling, sawing or cutting. The analyzation of the predetermined amount of the ligno may be made while the UAV is at or near the ligno or the predetermined amount of ligno may be brought to an analyzation station at a distance from the ligno. A selection of where to remove the predetermined amount of the ligno may be made by using the camera. Suspected rotten or insect infested area may be detected by the camera and thereafter a sample of such area may be removed and analysed. Different portions of a single ligno and different ligno may be categorized differently depending on the outcome of the analysis, i.e., depending on the ligno parameters a specific portion of a ligno may fall into one or a plurality of different categories. If a specific portion of a ligno may fall in a plurality of different categories a selection may be based on the value or the current demand in the market.

Growing conditions may for instance be #ligno per unit area and/or growth potential.

Growing condition may also be biotic environmental factors (interaction of organism of the same species and/or interaction of organisms of other species) such as mount of dead ligno/wood within a predetermined area, interaction and/or competition of other species, gas and fragrance from plants, temperature of other plants etc. Fungal infestation and insect infestation may be spread over a large area. It may be advantageous to harvest non infested ligno within a predetermined time after having detected an infested ligno in a predetermined area. Fungal and insects may spread over several km. Competition for water, nutrition, and sun hours may be within a distance of 0-50 m. Advantageous interaction/competition situations may be made through sorting out plants in predetermined positions in order to get optimal conditions for the remaining ones.

Growing conditions may also be abiotic environmental factors climate (temperature, precipitation etc), topography, ground temperature, geology, hydrology, vegetation, soil, earth deposit, soil depth, surface blockage, minerals, ground carbon contents, ground nitrogen content, ground carbon nitrogen ratio, PH value, bas kat ions, amount of trace elements, physical or chemical erosion, environmental condition, wind etc. Abiotic environmental factors may also be the type of land such as forest land, arable land, agricultural land, natural pasture, mountain impediment, protected area, power line area, military area, built up land etc.

At least one ligno parameter and/or growing condition may be used as a factor for determining the usage, demand, storage, quality of the at least a portion of ligno. This in turn may be used for determining the final destination of a particular portion of a ligno.

Gas sensors may be used to detect water quality (carbon oxide content, methane content, oxygen content etc.).

The UAV may have one or a plurality of propellers. In FIGS. 1-4 the UAV has 6 propellers arranged symmetrically around an origin.

The base station 120 may, when remotely controlled, be operated by at least one human being, whereas, when autonomously controlled, be a base station 120 with programmed software algorithms used for supporting the autonomous UAV and/or the means configured for harvesting at least a portion of a ligno. The base station 120 may be a stationary unit or a mobile unit.

The means for holding the ligno 105 may be at least one movable gripping arm. In various example embodiments the means for holding the ligno 105 may be one or a plurality of metal bars which may at least partially penetrate a ligno trunk. In various example embodiments the means for holding the ligno 105 may be a unit surrounding the ligno trunk and being able to change its holding area and thereby compress around the ligno trunk for securing purpose and decompress for releasing a ligno trunk or entering a ligno to be harvested. The means for holding the ligno 105 may comprise the sample detection means.

In various example embodiments the means configured for harvesting at least a portion of the ligno may be arranged with means for attaching itself to the ligno trunk. In various example embodiments the means configured for harvesting at least a portion of a ligno are also configured for moving up and down along the trunk of the ligno. The movement may be performed by at least one electrically driven wheel travelling on the ligno trunk. In various example embodiments at least one wheel may be electrically driven for enabling movement up and down the ligno trunk and at least one other wheel is arranged for friction reduction during the movement. In various example embodiments at least to wheels are configured to attach, secure and move the means configured to harvesting at least a portion of a ligno.

In various example embodiments the means configured for harvesting at least a portion of the ligno may also be configured for moving on ground. The movement can be made via a plurality of wheels or legs and/or as a tracked vehicle.

The UAV 100 and the means configured for harvesting at least a portion of the ligno may be communicating with each other via one or more of WiFi, Bluetooth, radio communication, telecommunication (3G, 4G, 5G), optical fibre and/or electrical wire. In various example embodiments the control unit and the UAV and/or the means configured for harvesting at least a portion of the ligno may be communicating with each other via one or more of WiFi, Bluetooth, radio communication, telecommunication (3G, 4G, 5G). Depending on the distance and/or communication quality between the control unit and the UAV and/or the means configured for harvesting at least a portion of a ligno the communication may change from one type of communication to another.

In various example embodiments the means configured for harvesting at least a portion of the ligno may be connectable to an underside of the UAV 100.

In various example embodiments the UAV 100 may comprise a power unit for powering the UAV 100 and the delimbing and cutting means 110. The power from the power unit in the UAV 100 may be delivered to the delimbing and cutting means 110 via at least one power cable. The power unit may be an electric motor and/or an internal combustion engine.

In various example embodiments the UAV 100 may comprise at least a first power unit for powering the UAV 100 and the delimbing and cutting means 110 may comprise at least a second power unit for powering the delimbing and cutting means 110. The power unit in the UAV 100 may be electrical and/or an internal combustion engine. The power unit in the delimbing and cutting means 110 may be electrical and/or an internal combustion engine. The holding means 105 may be powered by its own power unit or powered from the UAV and/or the delimbing or cutting power unit.

In various example embodiments the delimbing and cutting means 110 is configured for delimbing a ligno. The delimbing may be performed from top to bottom if the means configured for harvesting at least a portion of the ligno is initially arranged above the ligno to be harvested. The delimbing may be performed by one or a plurality of cutting means, snapping means, and/or shearing means. The cutting means may be by cutting chains and/or by rotary cutting disks. The cutting may be performed by a straight movement along the trunk of the means configured for harvesting at least a portion of a ligno and/or by a serpentine movement along the trunk by the means configured for harvesting at least a portion of a ligno.

In various example embodiments the delimbing and cutting means 110 may be configured to be in direct communication with a remote operator and/or a remote base station 120 or indirect communication via the UAV 100 with a remote operator and/or a base station 120. The indirect communication, i.e., the UAV 100 as access point, with the delimbing and cutting means 110 may be used if the same information is to be sent to both UAV 100 and the delimbing and cutting means 110. The UAV 100 may in various example embodiments work independently from a remote base station 120. The indirect communication may also be used if the UAV 100 is arranged in between the base station 120 and the delimbing and cutting means 110.

In various example embodiments the UAV and/or the means configured for harvesting at least a portion of a ligno may comprise means configured for automatically locating a ligno and/or a predetermined area to be harvested. The means configured for automatically locating a ligno and/or the predetermined area to be harvested may comprise at least a Global Navigation Satellite System, GNSS. The means configured for automatically locating a ligno and/or a predetermined area to be harvested may comprise at least one camera or optical sensor. The means configured for automatically locating a ligno and/or a predetermined area to be harvested may comprise at least a camera in combination with Artificial intelligence or machine learning algorithms for speeding up the detection of a suitable area to arrange the means configured to cut a ligno trunk.

Now returning to FIG. 1a where the UAV 100 is on its way to a ligno 135b to be harvested. The ligno 135b may be preselected, i.e., selected prior to arrival to the ligno 135. Alternatively, the ligno 135b may be selected by the UAV 100 in combination with the base station 120 once the UAV 100 is at or near a position above the ligno 135b. The selection may be performed by identifying a picture of the ligno 135b from above with stored pictures in the control station 120 and by means of a selection algorithm select a ligno for ligno thinning purpose or other selection criteria.

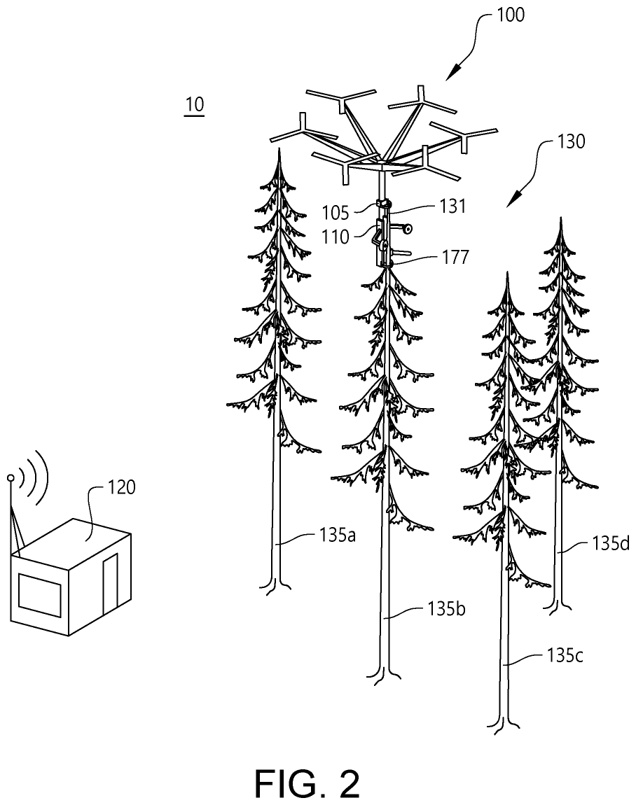

In FIGS. 2-4 a forest 130 comprises four ligno 135a, 135b, 135c, 135d, all of which may have equal or different ligno parameters and/or growing conditions. The forest 130 may of course have a larger or smaller amount of ligno than the depicted 4 as shown in FIGS. 2-4. A ligno to be harvested may be determined by at least one of the detected ligno parameters and/or growing conditions. In various example embodiments the order of harvesting ligno 135a, 135b, 135c, 135d may be selected out of minimizing a total harvesting time. In various example embodiments a particular ligno may be selected because there is a demand of such ligno parameters from a particular customer. In various example embodiments a particular ligno may be selected to be harvested due to a particular ligno thinning strategy, e.g., smallest or largest ligno in a group of ligno, diameter of the at least a portion of a ligno, length of the at least a portion of a ligno, ligno species of the at least a portion of a ligno and/or the weight of the at least a portion of a ligno, dry content, twig-free, rootstock, density, rot, discoloured, dead ligno and/or insect infested. Ligno parameters may be detected prior to arriving with the UAV 100 to the forest 130. This may be made manually and/or automatically. Manual detection may be made by human beings registering at least one ligno parameter in a digital database. Automatic ligno parameters may be made by a separate UAV and/or a land-based vehicle. Detection may be non-destructive and/or destructive.

Non-destructive methods may be made by visual inspection by a human being or by registering the ligno by a suitable optical means such as a camera. Destructive detection may be made by removing a predetermined amount of a ligno and analysing it on site or at a remote site. A ligno to be harvested may be selected depending on its distance to the final destination, e.g., choosing ligno with a particular set of ligno parameters as close to the final destination as possible. A ligno to be harvested may be selected in order to maximize the value of the total amount of harvested ligno in a particular time frame. A ligno to be harvested may be selected in order to maximize the value of the remaining ligno in the forest. A decision of how much of a particular ligno to be harvested may be made depending on at least one ligno parameter.

In a first example embodiment the delimbing and cutting means 110 is a delimbing tool only. This delimbing tool is used for delimbing trees autonomously and/or remotely from air according to the inventive method. When delimbing is finished the UAV is lifting up the delimbing tool and the tree will remain standing with its branches removed from its trunk. The delimbing method may comprise the following steps: detecting by at least one sensor on a UAV a tree to be harvested, positioning a harvesting tool comprising delimbing means carried by the UAV, by using information from the at least one sensor, at a predetermined distance above a canopy of the tree to be harvested, releasing the harvesting tool in a first mode from the UAV from the predetermined distance above the canopy of the tree to be harvested, and setting the harvesting tool in a second mode when the harvesting tool is below the canopy of the tree to be harvested while the harvesting tool has a certain speed >0 in a downward direction, wherein the first and second mode differ with respect to a tree receiving area of the delimbing means in the harvesting tool. In FIG. 1a the delimbing and cutting means 110 is in a first mode with a relatively large tree receiving area 177. In FIG. 2, which is after the delimbing and cutting means 110 has been dropped from the UAV 100, a tree top 131 is above the delimbing and cutting means 110. A top portion of the tree trunk is within the tree receiving area 177 of the delimbing and cutting means 110. At this moment the receiving area may be switched from the first mode, with the relatively large tree receiving area, to the second mode with a relatively small tree receiving area. The smaller tree receiving area may be adapted to the diameter of the tree trunk. The means for delimbing may be resiliently attached to the tree trunk and be configured to adapt its tree receiving area to the changing diameter as the delimbing tool is moved downwards along the tree trunk.

In a second embodiment, the delimbing and cutting means 110 is also comprising a cutting device for cutting the ligno trunk.

In various example embodiment the harvesting tool 105, 110 also comprising means for holding 105 the tree trunk for transportation away from its original location. The means for holding 105 may in a first embodiment be in a single unit together with the delimbing and cutting device 110. In another embodiment as depicted in FIGS. 2-4 the means for holding 105 and the delimbing and cutting means 110, which optionally may comprise a means for cutting the ligno trunk, may be separable from each other. The means for holding 105 and the delimbing and cutting means 110 may be connectable to each other via at least one winch mechanism as depicted in FIGS. 2-4. Alternatively, the means for holding 105 and the delimbing and cutting means 110 may be completely separable from each other, i.e., without any wires or rods in between them when they are removed from each other. The delimbing unit may comprise means configured for moving the delimbing tool up and down along the ligno trunk. The means configured for moving the delimbing tool up and down along the ligno trunk may be in form of one or a plurality of motorized wheels resiliently attached to the ligno trunk, which wheel(s) are configured for making traction against the outer surface of the ligno trunk for allowing movement of the delimbing tool upwards and downwards the ligno trunk. The motorized wheels may be autonomously and/or remotely operated.

In case of a delimbing and cutting means 110 and means for holding 105 the tree trunk which are separable to each other, two different delimbing scenarios may arise. In a first case, the delimbing and cutting means 110 may be dropped from the UAV together with the holding means 105 at a predetermined height H above the tree top 131. When the tree top 131 is detected to be within the tree receiving area 177, as depicted in FIG. 2, the delimbing and cutting means 110 may be released from the holding means 105. The holding means 105 may be attached to the tree trunk at a position relatively close to the tree top 131, which position is determined to be safe as a lifting position of the tree trunk to be cut at a predetermined position. In a second embodiment only the delimbing and cutting means 110 is dropped from the holding means 105 at a predetermined height H above the tree top 131. When the delimbing and cutting means 110 has the tree top within its tree receiving area 177 the delimbing tool is switched from the first mode with the larger tree receiving area to the second mode with the smaller tree receiving area 177. The holding means 105 may be lowered from the UAV 100 as the delimbing tool is delimbing the tree or when the delimbing tool 100 has finished the delimbing.

The height H at which the harvesting tool is dropped with the delimbing means in the first mode of the tree receiving area 177 may be at least 0.5 m, 1 m, 2 m or 3 m. One or a plurality of ligno parameters may determine the height H. Such determining ligno parameters may for instance be ligno type or ligno height. Growing conditions may also influence the choice of height H such as tree density around the tree to harvest, distance to next neighbour tree etc. In various example embodiments the height H may be a few cm, for instance when the tree is young and/or easy to delimb such as pine. In various example embodiments the height H may be several meters, for instance when the tree is old and/or relatively difficult to delimb such as birch. Larger older trees of particular species may require a relatively high height H in order to allow for gravity delimbing by knives provided on the delimbing delimbing and cutting means 110.

A relative position of a tree top and the UAV and/or the harvesting tool may be detected by at least one sensor attached to the UAV and/or the harvesting tool.

The UAV 100 and/or the harvesting tool 105, 110 may comprise 3 or more optical devices. It should also be understood that the optical devices may be unevenly distributed in many different configurations. For instance, a bracket may be provided between two motor support arms and one or a plurality of optical devices may be provided on the bracket. A first optical device may have a first field of view, a second optical device may have a second field of view, and a third optical device may have a third field of view. The first, second and third field of view may have a common overlapping volume. The UAV 100 may further comprising a control unit configured for creating a stereo image by combining at least one pair of images from any two of the first, second or third optical devices and wherein the first field of view, the second field of view and the third field of view are mainly in a direction in parallel with the yaw axis of the UAV pointing in a direction towards ground and any two of the first, second or third field of views are overlapping with each other in a focus plane. Stereo camera pairs may be used in computer vision to create a three-dimensional model of the surrounding environment. One requirement for such a system is for the cameras to be spaced apart from each other so that there is a measurable difference in the image seen by each camera, thereby allowing ranges in depth to be detected and quantified. The relative position and orientation of the two cameras may typically be rigidly maintained in order for stereo algorithms to work correctly.

A first camera may be separated from the second camera by a predetermined distance. The first camera may include a first field of view while the second camera may include a second field of view. An overlapping field exists where the first field of view overlaps the second field of view. The stereo camera pair may be configured to determine distances of objects present in the captured imagery. The overlapping portion of the images from each camera may be analysed by comparing corresponding features and determining separation distances associated with at least some of the corresponding features. For example, the images may include a first image captured by the first camera and a second image captured by the second camera. However, the images may include a first image captured by the first camera and a second image captured by the first camera at a later point in time, such as a next frame of imagery. The tree top 131 may be detected by means of at least one out of at least three different stereo images. At least one detector may detect when at least a portion of a tree is within the tree receiving area of the harvesting tool. The detector may be the stereo camera on another optical device provided on the UAV and/or the harvesting tool. In case no tree is detected within the tree receiving area the release of the harvesting tool may be autonomously stopped. An automatic stop may be performed if failure of detection of any tree within the tree receiving area is the case after a certain period of time after release of the harvesting tool from the UAV and/or within a predetermined speed interval of the harvesting tool without detection of any tree top within the tree receiving area 177 of the harvesting tool.

The tree receiving area 177 in the first mode may be at least twice as big as the tree receiving area 177 in the second mode. In various example embodiments the tree receiving area 177 in the first mode may be at least 10 times as big as the tree receiving area 177 in the second mode.

The harvesting tool 105, 110 may be attached to the UAV 100 with at least two cables each provided with a winch mechanism during the first and second mode. The harvesting tool may be moving in a direction essentially in parallel with the tree trunk of the tree to be harvested with a speed greater than 1 m/s when the switching from the first mode to the second mode is performed. In an alternative embodiment, the switching may be performed when the speed of the harvesting tool in a downward direction is greater than 2 m/s.

FIG. 1b depicts an alternative example embodiment of a harvesting tool 105, 110 provided inside a frustoconical device 102. A large opening 103 of the frustoconical device is provided below the tree receiving area 177 of the harvesting tool 105, 110. The frustoconical device 102 may be attached with its small opening to the drone 100 as depicted in FIG. 1b or attached with the small opening to the harvesting tool 105, 110 or with the small opening attached to the cables between the drone 100 and the harvesting tool 105, 110. In FIG. 1b the frustoconical device 102 is made of several elements configured to telescopically slide into each other allowing the frustoconical device to be in an extended mode, max length of the frustoconical device as depicted in FIG. 1b or in a collapsible mode in which the elements of the frustoconical device are inserted into each other making a total length of the frustoconical device at a minimum. In various example embodiments, the total length of the telescopic frustoconical device 102 may be varied. The length of the frustoconical device may be varied by means of one or a plurality of wires attached between at least two elements of the frustoconical telescopic device 102, which wire may be rolled in or rolled out and thereby retracting or extending the length of the frustoconical device 102. In FIG. 1c the frustoconical device 102 is a solid one-piece unit with fixed length. By providing a frustoconical device 102 around the harvesting tool with a large opening 103 at a lower position than the harvesting tool 105, 110 may make it easier to receive the tree top in the tree receiving area 177, this may be useful in windy conditions where the tree top 131 and the harvesting tool 105, 110 may not be in fixed positions relative to each other.

In FIG. 2 delimbing and cutting means 110 at least a portion of a ligno is on its way downwards along the tree trunk of the selected ligno 135b. A tree top 131 is above the tree receiving area 177 of the harvesting tool 105, 110. At this position the tree receiving area 177 may switch from a first mode with a large tree receiving area to a second mode with a smaller tree receiving area, which smaller area may be adapted to embrace resiliently on the ligno trunk in order to efficiently delimb the same. The smaller area in the second mode may be configured to adapt automatically to the increasing diameter of the ligno trunk as the means for harvesting at least a portion of a ligno is moving downwards on the ligno trunk. The tree receiving area 177 may be varied for both delimbing means and holding means in the harvesting tool 105, 110.

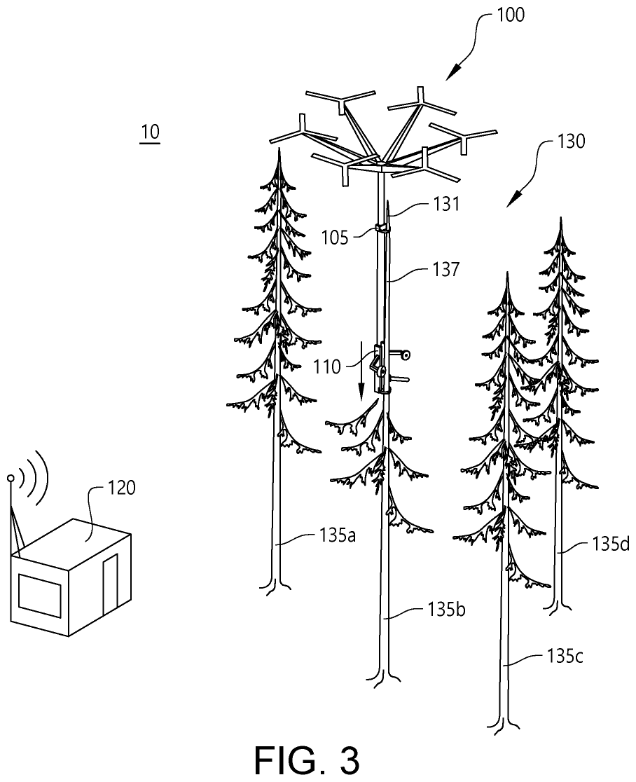

In FIG. 3 the autonomously controlled delimbing and cutting means 110 has been moved a distance down from the at least one means for gripping 105 the ligno trunk. On its way down the delimbing and cutting means 110 also has delimbed the ligno 135b leaving a bare ligno trunk 137 without twigs and limbs. The powering of the delimbing and cutting means 110 may be provided by the UAV 100 or by a power unit in the delimbing and cutting means 110. In case of power supplied from the UAV to the delimbing and cutting means 110 the power may be delivered via one or a plurality of power cables arranged on between the UAV 100 and the delimbing and cutting means 110. A power unit in the delimbing and cutting means 110 may be one or a plurality of battery packs. In various example embodiments a first battery pack may be used for communication with the UAV 100 and/or a base station 120. A second battery pack may be used for moving the delimbing and cutting means 110 up/down on a ligno trunk.

Instead of harvesting trees and/or bushes (ligno) by means of cutting at least a portion of the ligno, the ligno may be removed from ground with at least a portion of its root system. This removal may be made by using the UAV as removal means, i.e., gripping a ligno and using the upward traction power of the UAV for removing the ligno from ground. This technique may only be used for small ligno, for instance when an invasive art is to be removed from a particular area at an early stage for not causing damage on the remaining portion of the forest.

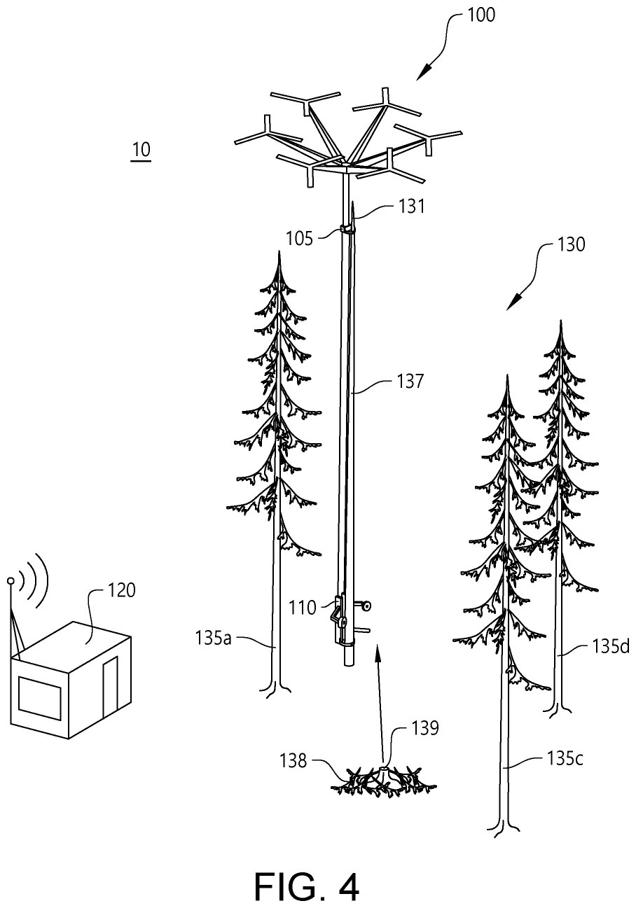

In various example embodiments means for gripping 105 the ligno trunk and the delimbing and cutting means 110 is not separating from each other during the delimbing of the ligno as depicted in FIGS. 3 and 4 but will follow each other during the delimbing of the ligno downwards the ligno trunk as one unit.

In FIG. 4 the ligno 135b has been delimbed into a bare ligno trunk 137, harvested and on its way to a location away from the original location of the ligno. What is left of the original ligno 135b at its original location is a pile of limbs 138 and a ligno stump 139. In the depicted example embodiment, the delimbing and cutting means 110 is still arranged on the ligno trunk when the ligno is transported away from the original location of the ligno. In various example embodiments it is provided means configured for directing the remotely and/autonomously UAV 100 with the at least a portion of a ligno to a final destination where the final destination is depending on the detected ligno parameters. In various example embodiments a first type of ligno species may be transported to a first final destination whereas a second type of ligno species may be transported to a second final destination. The final destination may have a first set of ligno parameters, final destination B may have a second set of ligno parameters and final destination C may have a third set of ligno parameters. The first, second and third set of ligno parameters may be different. Ligno parameters may for instance be a diameter of the at least a portion of a ligno, length of the at least a portion of a ligno, ligno species of the at least a portion of a ligno and/or the weight of the at least a portion of a ligno, dry content, twig-free, rootstock, density, rot, discoloured, dead ligno, insect infested. At least one of the final destinations A, B or C may be an intermediate storage on ground. At least one of the final destinations A, B or C may be a mobile storage, for instance a timber truck.

In various example embodiments, the final destination A may be for timber having a length within a predetermined interval. The final destination B may be for timber having a predetermined weight per unit of timber. The final destination C may be for rotten ligno, discoloured ligno, dead ligno and/or insect infested ligno.

In various example embodiments, the final destination A may be allocated with timber having a first set of ligno parameters and a requirement to be filled with timber prior to a final destination B which may have the same ligno parameters but will be filled with timber later in the ligno harvesting process. It may be that the final destination A is close to a road or at a timber truck, whereas final destination B may be an intermediate storage closer to the harvesting area compared to final destination A and far away from any available road.

In various example embodiments, the first final destination A may be for timber to be used as pulp. The second final destination B may be for building material, such as plank. The third final destination C may be for biomass material.

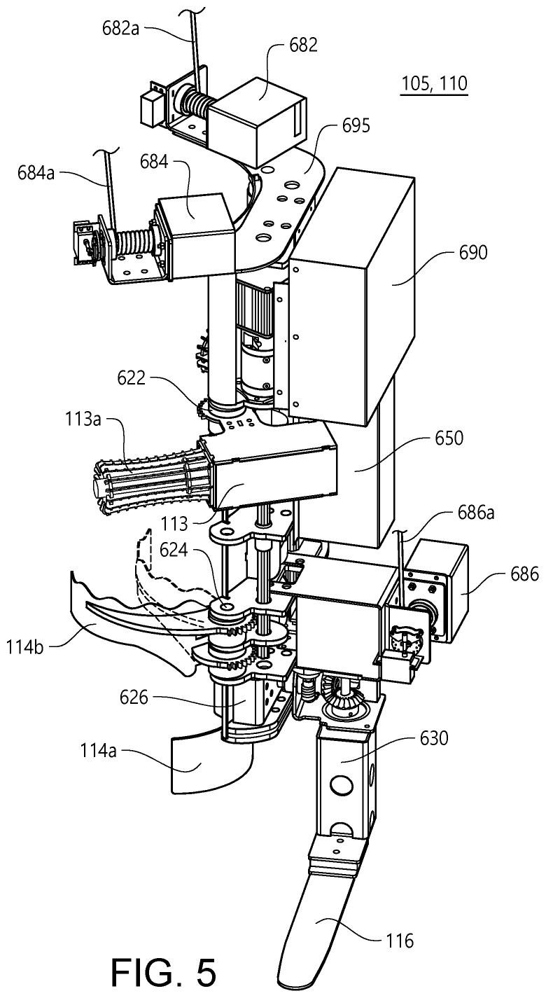

FIG. 5 illustrates an example embodiment of delimbing and cutting means 110 and the means for holding the tree 105. The delimbing and cutting means 110 and the means for holding the tree 105 may be provided at a distance from the UAV 100, here via a plurality of wires 682a, 684am 686a.

The holding means is in this example embodiment in the form of a first wheel 113a and a second wheel 115a. The first wheel 113a is provided on a first movable arm 113 and the second wheel 115a is provided on a second movable arm 115 (not shown). the first and second arms 113, 115 can be set to any position between a fully open position and fully closed position in order to allow to embrace a tree trunk and also to grip and release the same. The first arm 113 may rotate around a rotational axis 622.

The wheels 113a, 115a may be configured to roll on the surface of a tree trunk. The wheels may be made of metal and be provided with friction increasing ribs in order to increase traction of the wheel against the surface of the tree trunk and avoid or minimize the risk of slipping. The wheels 113a, 115a may be motorized. The wheels 113a, 115a may roll against a surface of a tree trunk and thereby move the delimbing and cutting means 110 and the means for holding the tree 105 from one position to another on the tree trunk. The wheels 113a, 115a may be pressed against the surface of a tree trunk with a predetermined pressure by movement of the first and second arms 113, 115 respectively. The wheels may lock onto a predetermined position of the tree trunk and thereby allow safe movement/transport of the tree trunk away from its original position. The first and second arms 113, 115 may be movable attached to the base structure 650. The delimbing and cutting means 110 and the means for holding the tree 105 further comprising the above mentioned first movable curved fixing/delimbing arm 114a and a second movable curved fixing/delimbing arm 114b. The first delimbing arm may move around a rotational axis 626. The second delimbing arm 114b may move around a rotational axis 624.

The first and second movable curved fixing/delimbing arms 114a, 114b may be set to any position between a fully open position and fully closed position in order to allow to embrace a tree trunk and also to fixing the same. The fixing/delimbing arms may have a sharp edge on its top portion and/or its bottom portion for delimbing the tree as the means configured for harvesting at least a portion of the tree moves along the trunk of the tree. The delimbing and cutting means 110 comprises a cutter 116. The cutter may be in the form of an electrically driven or internal combustion engine driven chain saw. The chain saw may be arranged movable in the delimbing and cutting means 110 in order to cut a tree while the means is in a fixed position on the trunk of the tree. In various example embodiments the delimbing and cutting means may only be a delimbing tool without any cutter for cutting the tree trunk.

The delimbing means 114a, 114b may be optional. The holding means 105 may be provided at a distance from the delimbing and cutting means 110. The holding means 105 may be attached at the delimbing and cutting means 110 with at least one wire or at least one metal bar or other suitable attaching means.

The holding means 105 and the delimbing and cutting means 110 may communicate with each other and/or independently of each other communicate with the UAV and/or the base station 120. At least one camera may be attached either on the UAV 100, the delimbing and cutting means 110 and/or the holding means 105.

In various example embodiments the harvesting tool 105, 110 may be made of two separable parts, a first part that is mainly configured for holding the tree 105 and a second part 110, capable of moving up and down along the trunk of the tree, which can delimb and/or cut the tree.

The means for holding 105 may change its position onto the tree trunk during cutting, delimbing, harvesting, transporting and/or debarking the tree trunk.

The base structure 650 further comprising a first winch motor 682, a second winch motor 684 and a third winch motor 686. The first winch motor 682 and second winch motor 684 may as depicted in FIG. 5 be provided at a distance from each other in a top portion 695 of the delimbing and cutting means 110 and the means for holding the tree 105. The third winch 686 motor may be provided at a distance from the first and second winch motors 682, 684. The first winch motor is provided with the first wire or cable 682a, the second winch motor 684 is provided with the second wire or cable 684a and the third winch motor is provided with the third wire or cable 686a. The first, second and/or third cables or wires may be extended or retracted individually and independently of each other by the respective winch motors. By changing the length of one or a plurality of wires or cables 682a, 684a, 686a the delimbing and cutting means 110 and the means for holding the tree 105 may be tilted in a desired orientation and/or its distance relative to the UAV may change, increase or decrease. The delimbing and cutting means 110 and the means for holding the tree 105 may further comprise a control unit 690. The control unit 690 may be provided with battery power for powering the first, second and third winch motors 682, 684, 686, the first and second arms 113, 115 and the first and second wheels 113a, 115a, the chainsaw 116 and the relative movement of the chain saw with respect to the base structure 650 as described hereinabove.

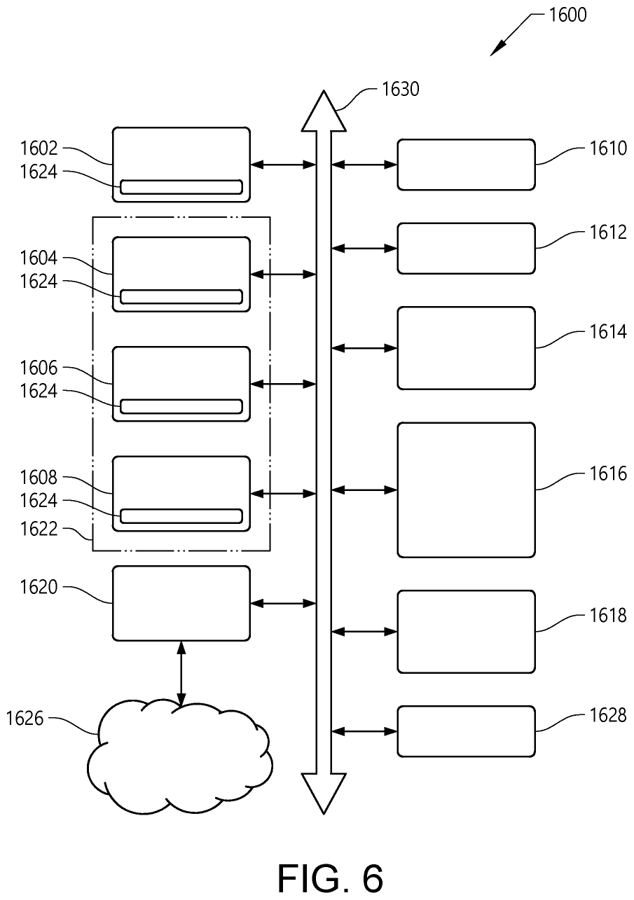

FIG. 6 illustrates a block diagram of an example machine 1600 upon which any one or more of the techniques (e.g., methodologies) discussed herein may perform. Examples, as described herein, may include, or may operate by, logic or a number of components, or mechanisms in the machine 1600. Circuitry (e.g., processing circuitry) is a collection of circuits implemented in tangible entities of the machine 1600 that include hardware (e.g., simple circuits, gates, logic, etc.). Circuitry membership may be flexible over time. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a machine readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine-readable medium elements are part of the circuitry or are communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time. Additional examples of these components with respect to the machine 1600 follow.

In alternative embodiments, the machine 1600 may operate as a standalone device or may be connected (e.g., networked) to other machines. In a networked deployment, the machine 600 may operate in the capacity of a server machine, a client machine, or both in server-client network environments. In an example, the machine 1600 may act as a peer machine in peer-to-peer (P2P) (or other distributed) network environment. The machine 1600 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

The machine (e.g., computer system) 1600 may include a hardware processor 1602 (e.g., a central processing unit (CPU), a graphics processing unit (GPU), a hardware processor core, or any combination thereof), a main memory 1604, a static memory (e.g., memory or storage for firmware, microcode, a basic-input-output (BIOS), unified extensible firmware interface (UEFI), etc.) 1606, and mass storage 1608 (e.g., hard drive, tape drive, flash storage, or other block devices) some or all of which may communicate with each other via an interlink (e.g., bus) 1630. The machine 1600 may further include a display unit 1610, an alphanumeric input device 1612 (e.g., a keyboard), and a user interface (UI) navigation device 1614 (e.g., a mouse). In an example, the display unit 1610, input device 1612 and UI navigation device 1614 may be a touch screen display. The machine 1600 may additionally include a storage device (e.g., drive unit) 1608, a signal generation device 1618 (e.g., a speaker), a network interface device 1620, and one or more sensors 1616, such as a global positioning system (GPS) sensor, compass, accelerometer, gyro, optical sensors or other sensor. The machine 1600 may include an output controller 1628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

Registers of the processor 1602, the main memory 1604, the static memory 1606, or the mass storage 1608 may be, or include, a machine readable medium 1622 on which is stored one or more sets of data structures or instructions 1624 (e.g., software) embodying or utilized by any one or more of the techniques or functions described herein. The instructions 1624 may also reside, completely or at least partially, within any of registers of the processor 1602, the main memory 1604, the static memory 1606, or the mass storage 1608 during execution thereof by the machine 1600. In an example, one or any combination of the hardware processor 1602, the main memory 1604, the static memory 1606, or the mass storage 1608 may constitute the machine-readable media 1622. While the machine readable medium 1622 is illustrated as a single medium, the term “machine readable medium” may include a single medium or multiple media (e.g., a centralized or distributed database, and/or associated caches and servers) configured to store the one or more instructions 1624.

The term “machine readable medium” may include any medium that is capable of storing, encoding, or carrying instructions for execution by the machine 1600 and that cause the machine 1600 to perform any one or more of the techniques of the present disclosure, or that is capable of storing, encoding or carrying data structures used by or associated with such instructions. Non-limiting machine-readable medium examples may include solid-state memories, optical media, magnetic media, and signals (e.g., radio frequency signals, other photon-based signals, sound signals, etc.). In an example, a non-transitory machine-readable medium comprises a machine-readable medium with a plurality of particles having invariant (e.g., rest) mass, and thus are compositions of matter. Accordingly, non-transitory machine-readable media are machine readable media that do not include transitory propagating signals. Specific examples of non-transitory machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 1624 may be further transmitted or received over a communications network 1626 using a transmission medium via the network interface device 1620 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi(R), IEEE 802.16 family of standards known as WiMax(R)), IEEE 802.15.4 family of standards, peer-to-peer (P2P) networks, among others. In an example, the network interface device 1620 may include one or more physical jacks (e.g., Ethernet, coaxial, or phone jacks) or one or more antennas to connect to the communications network 1626. In an example, the network interface device 1620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 1600, and includes digital or analogue communications signals or other intangible medium to facilitate communication of such software. A transmission medium is a machine readable medium.

The system may further comprise means for determining the number of UAV to be used together for transporting at least one portion of a ligno depending on the at least one ligno parameter and/or the distance between an original location of the at least a portion of a ligno to and the final destination. Long and/or heavy portions of ligno and/or a transport of a plurality of portions of ligno may require more than one UAV for transporting the portion of the ligno(s) from its original location to its final destination. At least one ligno parameter may be used to allocate the correct number of UAV to be used in synchronism for transporting the portions of ligno(s). The plurality of UAV may either attach to the portion of ligno to be transported or attach to another UAV for synchronously transporting the portion of ligno away from its original location to its final destination. The attachment of one UAV to another UAV may be made directly via a connection arrangement or via a wire or bar in between the two UAV. A plurality of UAV may also be necessary if the distance between the original location and the final destination is very long. If the distance between the original location and the final destination is long, an intermediate storage location in between the original location and the final destination may be necessary for later pick up and transport to the final destination. By using a plurality of UAV in synchronism may be advantageous since smaller UAVs may be used which is easier to handle and easier to use in a dense forest. Synchronization of a plurality of UAV for working together in transporting at least a portion of a ligno may be made through a base station and/or a master UAV. When it is determined that more than one UAV is needed, one of the UAV may be assigned a master role and the other UAV a servant role. The master role may be assigned to the UAV first approaching the portion of ligno to be transported or to a specific type of UAV. Alternatively, the plurality of UAV may be attached together for transport and the base station assigned one of them as a master and the other as servant UAV. Each and every UAV may communicate with each other and to the base station. In yet an alternative embodiment the base station is the synchronization unit, i.e., all UAV are assigned as servant UAV and follow one and the same instructions sent out from the base station.

In various example embodiments single UAV transportation may be prioritized before plurality of UAV transportation. This may be the case in an early stage of harvesting when the forest is still dense and there are lots of UAV available.

In various example embodiments transportation is based on total lift capacity of the UAV(s). A transportation optimization may in such case be based on the order the ligno should be picked up in order to minimize the clearing of a particular area. In various example embodiments only ligno having a predetermined ligno parameter should be prioritized before all other ligno parameters and/or growing conditions.

In various example embodiments a particular type of UAV, size and/or capacity may be used depending on at least on ligno parameter. In various example embodiments ligno parameters sent to the base station may allocate a particular type of UAV out of a UAV fleet which may make the transportation as effective as possible.

Ligno parameters may be detected by non-destructive evaluation, such as camera or optical sensors. Ligno parameters may also be detected by removing physical sample from the ligno and analysing the sample. The removal may be in form of cutting drilling or sawing and predetermined amount of the ligno at a predetermined position. The analysing may take place directly in the UAV or means attached to the UAV. Alternatively, the analysing may be made at a remote location from the ligno. Ligno parameter(s) may be detected by means attached to the same UAV which is used for transporting/harvesting the portion of ligno and/or by a human being prior to harvesting/transportation and/or by a land based remotely and/or autonomously controlled Unmanned Vehicle (100) and/or by means attached to a separate UAV only used for detecting tree parameters and/or growing conditions. In various example embodiments detection of ligno parameters and/or growing conditions may be made simultaneously and by separate means (UAV, human being, remotely and/or autonomously controlled Unmanned Vehicle) as harvesting and/or transportation in a particular area.

Instead of as in FIG. 4 delimbing and cutting the full ligno, the ligno may be harvested in sections starting from above and going down the trunk of the ligno. When a section of the ligno has been harvested, the delimbing and cutting means 110 may be left on the still uncut portion, the stump, of the ligno while the UAV is transporting away the harvested portion from the original location of the ligno. A cutting position on a ligno trunk may be determined before arriving with means for cutting to a particular ligno, i.e., it may have been detected by a human or information may be taken from data storage. The cutting position may be determined during harvesting and/or transporting. In such case the determination of a cutting position may be made by means of at least one camera attached to the UAV. The cutting position may also be determined by a previous cutting position, i.e., when a ligno is first cut for producing a first harvested ligno trunk the second cut on the remaining ligno may be determined with respect to the first cut for producing a ligno trunk with a predetermined length. The remaining ligno may be a transported ligno, un unharvested ligno or a ligno laying on ground. A cutting position may also be selected to be within a predetermined interval of the ligno trunk. The means for cutting a ligno may also be capable of debarking and/or delimbing a ligno trunk.

Delimbing means may be arranged on a top portion and on a bottom portion of the delimbing and cutting means 110. By arranging the delimbing means on both sides of the delimbing and cutting means 110 makes it possible to provide the delimbing and cutting means 110 from above on the ligno or from root of the ligno. The delimbing means is provided at the front position with respect to the direction of movement of the delimbing and cutting means 110.

In various example embodiments the delimbing and cutting means 110 may be provided by the UAV directly on a portion of the ligno to be harvested where there are no limbs.

In various example embodiments the harvesting tool 105, 110 may be made of two separable parts, a first part that is mainly configured for holding the ligno 105 and a second part 110, capable of moving up and down along the trunk of the ligno, which can delimb and/or cut the ligno.

The means for holding 105 may change its position onto the ligno trunk during cutting, delimbing, harvesting, transporting and/or debarking the ligno trunk.

A plurality of UAV may work together synchronously for transporting a harvested portion of a ligno or a plurality of harvested ligno. This may be arranged so that a first UAV is a master UAV and at least a second UAV is a slave UAV. The master UAV may grip the ligno to be harvested at a predetermined position on its trunk. The at least one slave UAV may be attached to the master UAV via wires. The at least one slave UAV may be arranged at an elevated position with respect to the master UAV. A synchronisation unit makes sure the master UAV and the at least one slave UAV works in synchronisation with respect to movement and distance to each other. The synchronisation unit may be arranged in the master UAV or arranged in the control unit controlling the master UAV and the at least one slave UAV.

Instead of a single UAV gripping the portion of the ligno to harvest a plurality of UAVs may grip the same ligno to be harvested.

In various example embodiments of the present invention the UAV is designed to be capable of flying as to control position, velocity, orientation and rotational speed and via a rigid connection impart its motion to the means for cutting/delimbing the ligno. In this embodiment the UAV controls the movement of the means for cutting/delimbing the ligno.

In various example embodiments of the present invention the UAV may be used to reduce load on the cutting means 116 during cutting. This may be performed by first holding a predetermined portion of the ligno by the holding means 105 and thereafter apply a lift force by the UAV while cutting the ligno by the delimbing and cutting means 110. This may be advantageous since a reduced load on the cutting means 116 from the weight of the ligno may increase the efficiency of the cutting procedure and/or require less power compared to cutting a ligno with the full load onto the cutting means 116.

In various example embodiments the UAV and the means configured for harvesting at least a portion of a ligno may be separated from each other and reconnected with each other. One or a plurality of cameras or other suitable position sensors may be used for the reconnection procedure.

In various example embodiments a plurality of UAV may be used for transporting a plurality of trees or tree trunks.

A ligno parameter may be the number of branches and its location on a ligno. A ligno parameter may be the shape of the branches. A ligno parameter may be the number of dry branches or a dry branch.

A ligno parameter may be defects generated by weather, e.g., storm, fire, torrential rain, dry periods etc. In various example embodiments, a particular type of tree may not be harvested within a predetermined time period after a rainy season such as birch.

A ligno parameter may be a ligno gene or a set of genes. Ligno genes may be detected in a lab. Ligno genes may also be present together with the position of the ligno when sowing the ligno.

A ligno parameter may be the number of leaves or fir needles. The number of leaves or fir needles may be estimated by detecting a spectral density per unit area.

A growing condition may be hydrology of a predetermined area. Hydrology may be the presence of running water and/or soil moisture.

A growing condition may be climate and/or meteorological variables such as wind, humidity, air pressure, radiation etc. A growing condition may be the weather during a particular season, a depth of snow, average wind speed, sensitivity to storm damage. A temperature, fire and/or snow depth etc. during a particular time-period may be a determining factor to harvest or not and/or if special equipment is needed.

Abiotic factors such as soil quality may be a growing condition and a determining factor for ligno parameter. Abiotic factors in combination with a detection of annual rings, the shape of the tree, and surrounding vegetation may give a good indicator of the quality of a ligno. Visual inspection of a ligno in combination with historical weather data may give a strong indication of the quality/value of a ligno.

A final destination of a ligno may not only be determined in longitude and latitude but also in height above ground level or sea level. The height and/or spatial position in relation to other portions of trees, ground or other objects variable may be useful if different types of ligno parameters are to be stored on the same location but being transported to yet another location at different times. The final destination may be a fixed position, a vehicle, but also a position in relation to another object, portion of the landscape and/or a predetermined area or volume. The knowledge about the spatial location of a particular ligno parameter in a pile of ligno trunks may be logistically advantageous.

A growing condition and/or a ligno parameter may determine the final quality of wood such as flat bend, edge bend and/or skew.

In various example embodiments a ligno may be cut in several portions and the portions may be laid on ground. One of the smallest portions may be transported first and based on at least one of its tree parameters the weight of the remaining portions may be estimated.

Cutting a portion of a tree or a number of full trees may be performed for increasing the value of the remaining portion of the forest.

### Feasible Modifications of the Invention

The invention is not limited only to the embodiments described above and shown in the drawings, which primarily have an illustrative and exemplifying purpose. This patent application is intended to cover all adjustments and variants of the preferred embodiments described herein, thus the present invention is defined by the wording of the appended claims and the equivalents thereof. Thus, the equipment may be modified in all kinds of ways within the scope of the appended claims.

In various example embodiments it is provided a system (10) for remote and/or autonomous harvesting at least a portion of a tree, the system (10) comprising:
a first remotely and/or autonomously controlled Unmanned Aerial Vehicle (100), UAV, comprising, at least one means for holding (105) the harvested portion of the tree and being configured for transporting the harvested portion of the tree away from the original location of the tree, and
a second remotely and/or autonomously controlled Unmanned Aerial Vehicle (100), UAV, comprising, at least one means for harvesting at least a portion of a tree,
at least one means for detecting the tree to be harvested,
a base station (120) for communication with the first and/or second UAV.

The means for detecting the tree to be harvested may be arranged on the first UAV, the second UAV and/or a third UAV and/or a remotely and/or autonomously controlled land-based vehicle. The third UAV and/or the autonomously controlled land-based vehicle may be in direct communication with the base station and/or indirect communication with the base station. Indirect communication may be via the first and/or the second UAV.

In various example embodiments it is provided a system (10) for remote and/or autonomous selecting at least a portion of a ligno to be cut, the system (10) comprising:
a remotely and/or autonomously controlled Unmanned Aerial Vehicle (100), UAV, comprising, at least one means for cutting the at least a portion of a ligno,
means for detecting the at least a portion of a ligno to be cut,
means for detecting at least one ligno parameter of at least a portion of a ligno and/or at least one growing condition of at least a portion of a ligno,
a base station (120) for communication with the UAV, and
means configured for selecting at least a portion of a ligno to be cut depending on at least one detected ligno parameter and/or at least one detected growing condition of the cut ligno and/or of a remaining portion of a ligno and/or of at least one ligno grown within a predetermined distance from the cut ligno.

Harvesting may mean felling of ligno and preparing them for transport away from its original location. It includes both thinning and clearfelling or clearcutting operations. Harvesting may be made depending on current demand for a particular tree parameter. Harvesting may be made depending on current available storage capacity. Harvesting may be made depending on season/temperature for maximizing a particular tree parameter. Harvesting may be made for maximizing the quality/growth potential of the remaining ligno in a particular area. Harvesting may also be made for maintaining a forest having a diverse age. Harvesting may also be made for maintaining a forest of a particular species, age and/or composition. Harvesting may be made for maintaining cultural and/or aesthetic values.

For instance, the disclosed system may also transport already harvested ligno or portions of ligno laying on ground. A plurality of UAV may be used for removing a plurality of ligno laying on ground to a final destination. A plurality of UAV working together in synchronism may take one or a plurality of ligno or portions of ligno at the same time. The selection of ligno to be transported may be made depending on the total weight of the ligno or portions of ligno to be transported. The plurality of UAV may have a maximum load capacity and maximum range capacity. Ligno or portions of ligno may be selected depending on their location, weight, time and the current state of the UAV, i.e., remaining charge and/or fuel.

In various example embodiments of the present invention at least a portion of a ligno is removed and left on ground. The portion can be anything from a branch, a top section to a full ligno. Full ligno may be removed without being taken care of, a so-called scrap ligno. A scrap ligno may have a relatively low value in comparison with other surrounding trees and/or for letting the remaining ligno in a particular area to obtain the best possible growing conditions.

Throughout this specification and the claims which follows, unless the context requires otherwise, the word “comprise”, and variations such as “comprises” or “comprising”, will be understood to imply the inclusion of a stated integer or steps or group of integers or steps but not the exclusion of any other integer or step or group of integers or steps.

1-18. (canceled)

19. A method for remotely and/or autonomously harvesting a tree from air, said method comprising the steps of:
detecting by at least one sensor on a UAV (100) a tree to be harvested,
positioning a harvesting tool (105) comprising delimbing means (114) carried by said UAV (100), by using information from said at least one sensor, at a predetermined distance H above a canopy of said tree to be harvested,
releasing said harvesting tool (105) in a first mode from said UAV (100) from said predetermined distance H above said canopy of said tree to be harvested, and
setting said harvesting tool (105) in a second mode when said harvesting tool (105) has the tree top (131) of said tree to be harvested within its tree receiving area (177),
wherein:
at least a portion of said harvesting tool (105) is below said tree top (131) of said tree to be harvested while said harvesting tool (105) has a certain speed >0 in a downward direction,
said first and second mode differ with respect to said tree receiving area (177) of said delimbing means (114) in said harvesting tool (105), and
said tree receiving area (177) refers to the area in between open and closed delimbing means (114).

20. The method according to claim 19, further comprising the step of detecting a relative position of said tree top (131) of said tree to be harvested and said UAV (100).

21. The method according to claim 20, wherein said tree top (131) of said tree to be harvested is detected by means of at least one out of at least three different stereo images.

22. The method according to claim 19, further comprising the step of delimbing said tree to be harvested by the gravity force induced by said harvesting tool (105) when released from said UAV (100).

23. The method according to claim 19, further comprising the step of detecting with at least one detector a portion of a tree within said tree receiving area (177) of said harvesting tool (105).

24. The method according to claim 22, further comprising the step of stopping said release of said harvesting tool (105) in case of failure to detect any portion of a tree within said tree receiving area (177).

26. The method according to claim 24, wherein said stopping is occurring within a predetermined time interval after the start of releasing said harvesting tool (105) from said UAV (100) and/or within a predetermined speed interval of said harvesting tool (105) without detection of any tree top (131) within said tree receiving area (177) of said harvesting tool (105).

27. The method according to claim 19, wherein said harvesting tool (105) is triggered to be set into said second mode by at least one of the group of following triggers: at a predetermined distance between said UAV (100) and said harvesting tool (105), when a tree is detected to be within said tree receiving area (177) of said harvesting tool (105), a predetermined speed of said harvesting tool (105) and/or within a predetermined time interval after said harvesting tool (105) is released from said UAV (100).

28. The method according to claim 23, wherein said detection of a tree within said tree receiving area (177) of said harvesting tool (105) is made by at least one optical device provided on said UAV (100).

29. The method according to claim 23, wherein said detection of a tree within said tree receiving area (177) of said harvesting tool (105) is made by at least one optical device provided on said harvesting tool (105).

30. The method according to claim 19, wherein a switching from said first mode to said second mode is performed autonomously.

31. The method according to claim 19, wherein said tree receiving area (177) in said first mode is at least twice as big as said tree receiving area (177) in said second mode.

32. The method according to claim 19, wherein said tree receiving area (177) in said second mode is adapted to the diameter of the tree trunk of said tree to be harvested.

33. The method according to claim 19, wherein said harvesting tool (105) is attached to said UAV (100) with at least two cables each provided with a winch mechanism during said first and second mode.

34. The method according to claim 19, wherein said harvesting tool (105) is moving in a direction essentially in parallel with the tree trunk of said tree to be harvested with a speed greater than 1 m/s when said switching from said first mode to said second mode is performed.

35. The method according to claim 19, wherein one or more of the recited steps are implemented via at least one control unit (690) containing one or more computer processors.

36. A computer program comprising program code means for performing the method according to claim 19.

37. A computer-implemented method for harvesting a tree from air, said method comprising the steps of:
detecting with at least one sensor a tree to be harvested,
positioning, via execution of at least one control unit (690), a harvesting tool (105) comprising delimbing means (114) carried by a UAV (100), by using information from said at least one sensor, at a predetermined distance above a canopy of said tree to be harvested,
releasing, via execution of at least one control unit (690), said harvesting tool (105) in a first mode from said UAV (100) from said predetermined distance above said canopy of said tree to be harvested, and
setting, via execution of at least one control unit (690), said harvesting tool (105) in a second mode when said harvesting tool (105) has the tree top (131) of said tree to be harvested within its tree receiving area (177),
wherein:
at least a portion of said harvesting tool (105) is below said tree top of said tree to be harvested while said harvesting tool (105) has a certain speed >0 in a downward direction,
said first and second mode differ with respect to said tree receiving area (177) of said delimbing means (114) in said harvesting tool (105), and
said tree receiving area (177) refers to the area in between open and closed delimbing means (114).
